(19) United States
(12) Patent Application Publication
(10) Pub. No.: US 2025/0118921 A1
(43) Pub. Date: Apr. 10, 2025

(54) CONNECTOR AND ASSEMBLY

(71) Applicant: Japan Aviation Electronics Industry, Limited, Tokyo (JP)

(72) Inventor: Osamu HASHIGUCHI, Tokyo (JP)

(73) Assignee: Japan Aviation Electronics Industry, Limited, Tokyo (JP)

(21) Appl. No.: 18/813,301

(22) Filed: Aug. 23, 2024

(30) Foreign Application Priority Data
Oct. 10, 2023 (JP) 2023-175418

(51) Int. Cl. H01R 13/422; H01R 12/71

(52) U.S. Cl. CPC H01R 13/422; H01R 12/716

(57) ABSTRACT

A connector has an insulator and a plurality of contacts. The insulator has a partition portion. The partition portion is formed with a plurality of accommodating ditches. The accommodating ditches are classified into two groups. The accommodating ditches of one of the groups are different in position from the accommodating ditches of a remaining one of the groups in a pitch direction. Each of the accommodating ditches has a receiving portion. In a width direction, the receiving portion extends across a middle of the partition portion. The contacts correspond to the accommodating ditches, respectively. Each of the contacts is partially accommodated in the corresponding accommodating ditch. Each of the contacts has a distal end portion. The receiving portion of each of the accommodating ditches is able to receive, at least in part, the distal end portion of the corresponding contact upon mating of the connector with a mating connector.

### CROSS REFERENCE TO RELATED APPLICATIONS

This application is based on and claims priority under 35 U.S.C. § 119 to Japanese Patent Applications No. JP 2023-175418 filed Oct. 10, 2023, the contents of which are incorporated herein in their entirety by reference.

### BACKGROUND OF THE INVENTION

This invention relates to a connector which has at least two contact rows and a partition portion, and to an assembly.

JPB 7109303 (Patent Document 1) discloses a connector 900 of this type. As shown in FIG. 34, the connector 900 of Patent Document 1 has a first housing 910, a fixed housing 920 and a plurality of first contacts 930, or contacts 930. The first housing 910 has a separation wall 912, or a partition portion 912. The contacts 930 form two contact rows. The partition portion 912 is positioned between the two contact rows in a Y-direction, or in a width direction.

A connector such as the connector 900 of Patent Document 1 is required to have a reduced size in the width direction.

### SUMMARY OF THE INVENTION

It is therefore an object of the present invention to provide a connector which can have a reduced size in a width direction.

One aspect (first aspect) of the present invention provides a connector mateable along a mating direction with a mating connector which has a mating contact. The connector has an insulator and a plurality of contacts. The insulator holds the contacts. The insulator has a partition portion. The partition portion has opposite faces in a width direction perpendicular to the mating direction. The partition portion is formed with a plurality of accommodating ditches. The accommodating ditches are classified into two groups. The accommodating ditches of each of the groups are arranged in a pitch direction perpendicular to both the mating direction and the width direction. The accommodating ditches of one of the groups are positioned on one of the opposite faces of the partition portion. The accommodating ditches of a remaining one of the groups are positioned on a remaining one of the opposite faces of the partition portion. The accommodating ditches of one of the groups are different in position from the accommodating ditches of a remaining one of the groups in the pitch direction. Each of the accommodating ditches has a receiving portion. In the width direction, the receiving portion extends across a middle of the partition portion. The contacts correspond to the accommodating ditches, respectively. Each of the contacts is partially accommodated in the corresponding accommodating ditch. The contacts form two contact rows. Each of the contacts has a contact point and a distal end portion. The contact point is brought into contact with the mating contact when the connector and the mating connector are mated with each other. The receiving portion of each of the accommodating ditches is able to receive, at least in part, the distal end portion of the corresponding contact upon the mating of the connector with the mating connector.

Another aspect (second aspect) of the present invention provides an assembly comprising the connector of the first aspect and the mating connector. The mating connector comprises a mating insulator and a plurality of the mating contacts. The mating insulator holds the mating contacts. The mating insulator has two outer walls. Each of the outer walls extends in the pitch direction. Each of the outer walls is formed with a plurality of mating receiving portions. Each of the mating receiving portions pierces the outer wall in the width direction. The mating contacts form mating contact rows. The mating contact rows include an outermost contact row which is positioned outermost of the mating contact rows in the width direction. Each of the mating contacts has a mating distal end portion. The mating receiving portion is able to receive the mating distal end portion of the mating contact of the outermost contact row upon the mating of the connector with the mating connector.

The connector of the present invention is configured as follows: the partition portion is formed with the plurality of accommodating ditches; the accommodating ditches are classified into the two groups; the accommodating ditches of the one of the groups are different in position from the accommodating ditches of the remaining one of the groups in the pitch direction; each of the accommodating ditches has the receiving portion; and, in the width direction, the receiving portion extends across the middle of the partition portion. This enables the partition portion of the connector of the present invention to have a reduced thickness in the width direction. Specifically, the connector of the present invention can have a reduced size in the width direction.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a front view showing an assembly according to a first embodiment of the present invention. In the figure, a connector and a mating connector are in an unmated state where the connector and the mating connector are not mated with each other.

FIG. 2 is a cross-sectional view showing the assembly of FIG. 1, taken along line A-A.

FIG. 3 is another front view showing the assembly of FIG. 1. In the figure, the connector and the mating connector are in the middle of their mating process.

FIG. 4 is a cross-sectional view showing the assembly of FIG. 3, taken along line B-B.

FIG. 5 is yet another front view showing the assembly of FIG. 1. In the figure, the connector and the mating connector are in a mated state where the connector and the mating connector are mated with each other.

FIG. 6 is a cross-sectional view showing the assembly of FIG. 5, taken along line C-C.

FIG. 7 is another cross-sectional view showing the assembly of FIG. 5, taken along line D-D.

FIG. 8 is an upper, perspective view showing the connector which is included in the assembly of FIG. 1.

FIG. 9 is a top view showing the connector of FIG. 8.

FIG. 10 is a front view showing the connector of FIG. 8.

FIG. 11 is a cross-sectional view showing the connector of FIG. 10, taken along line E-E.

FIG. 12 is another cross-sectional view showing the connector of FIG. 10, taken along line F-F.

FIG. 13 is a side view showing the connector of FIG. 8.

FIG. 14 is a bottom view showing the connector of FIG. 8.

FIG. 15 is a perspective view showing a contact of a first contact row which is included in the connector of FIG. 8.

FIG. 16 is a perspective view showing a modification of the contact of FIG. 15.

FIG. 17 is a top view showing a movable housing which is included in the connector of FIG. 9.

FIG. 18 is a front view showing the movable housing of FIG. 17.

FIG. 19 is a cross-sectional view showing the movable housing of FIG. 18, taken along line G-G.

FIG. 20 is another cross-sectional view showing the movable housing of FIG. 18, taken along line H-H.

FIG. 21 is a lower, perspective view showing the mating connector which is included in the assembly of FIG. 1.

FIG. 22 is a bottom view showing the mating connector of FIG. 21.

FIG. 23 is a front view showing the mating connector of FIG. 21.

FIG. 24 is a cross-sectional view showing the mating connector of FIG. 23, taken along line I-I.

FIG. 25 is a top view showing the mating connector of FIG. 21.

FIG. 26 is a perspective view showing a mating contact of a first mating contact row which is included in the mating connector of FIG. 21.

FIG. 27 is a perspective view showing a connector which is included in an assembly according to a second embodiment of the present invention.

FIG. 28 is a top view showing the connector of FIG. 27.

FIG. 29 is a front view showing the connector of FIG. 27.

FIG. 30 is a cross-sectional view showing the connector of FIG. 29, taken along line J-J.

FIG. 31 is a bottom view showing the connector of FIG. 27.

FIG. 32 is a perspective view showing a first contact of a first contact row which is included in the connector of FIG. 27.

FIG. 33 is a perspective view showing a second contact of a second row which is included in the connector of FIG. 27.

FIG. 34 is a perspective view showing a connector of Patent Document 1. In the figure, a part of the connector is enlarged and illustrated.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### First Embodiment

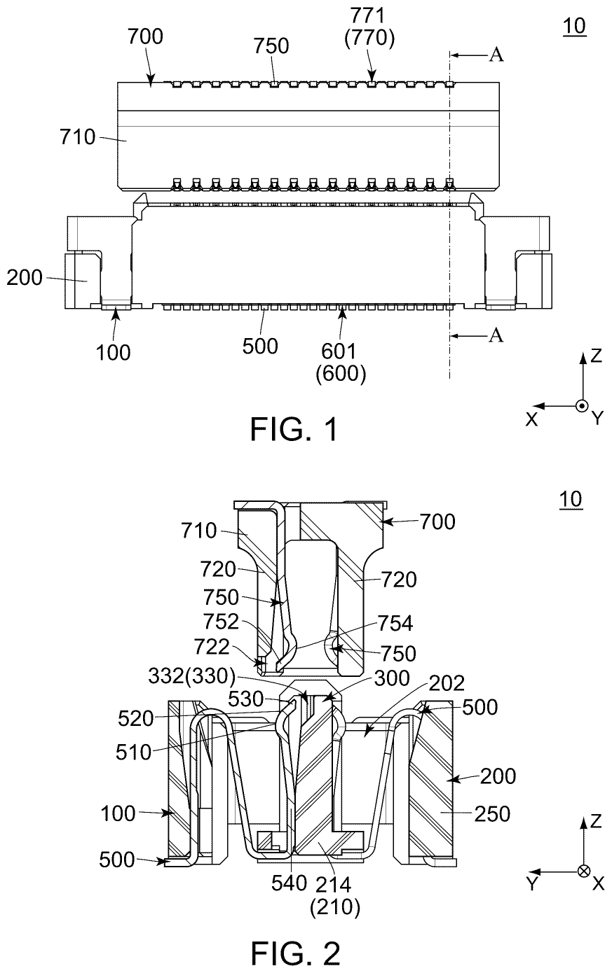

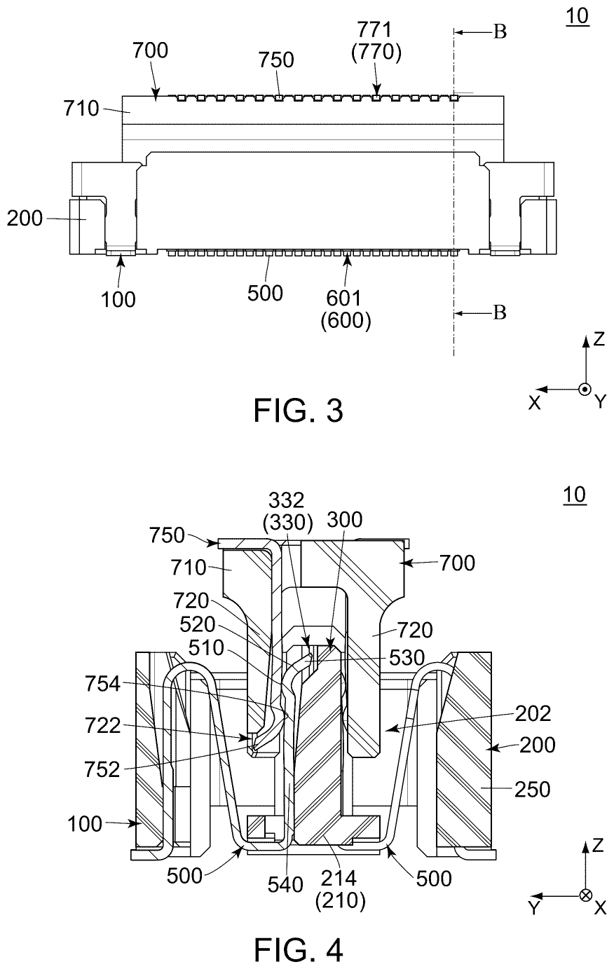

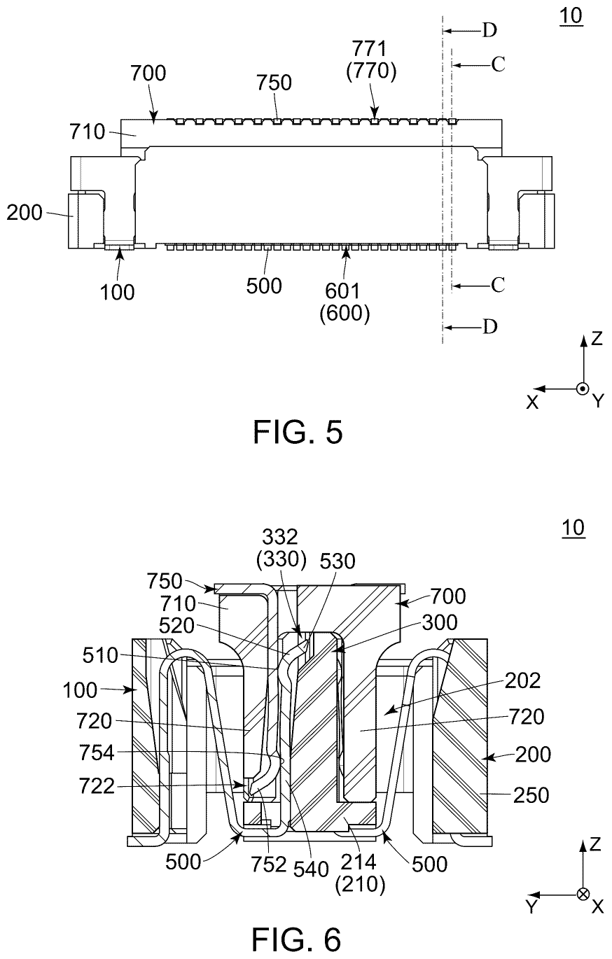

As shown in FIG. 1, an assembly 10 according to a first embodiment of the present invention comprises a connector 100 and a mating connector 700.

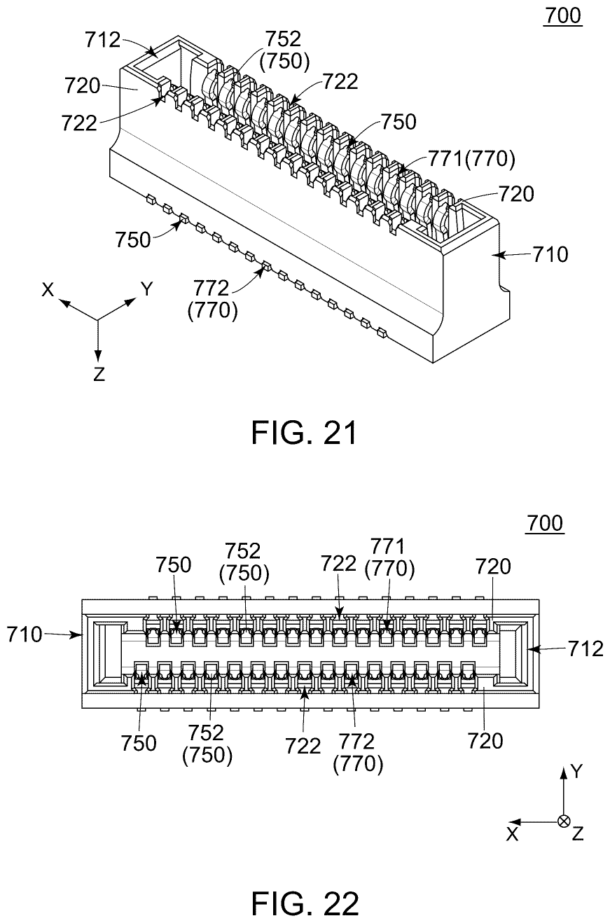

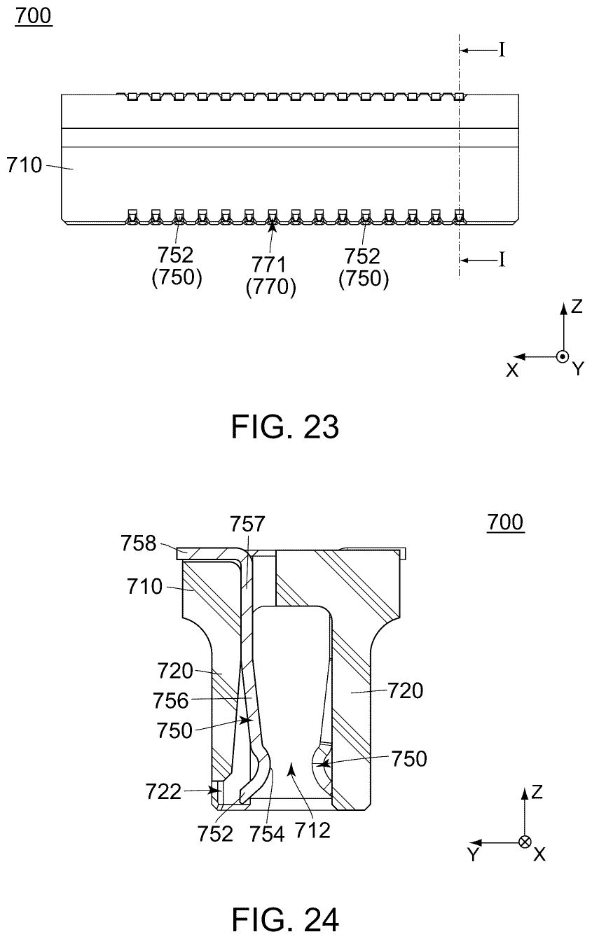

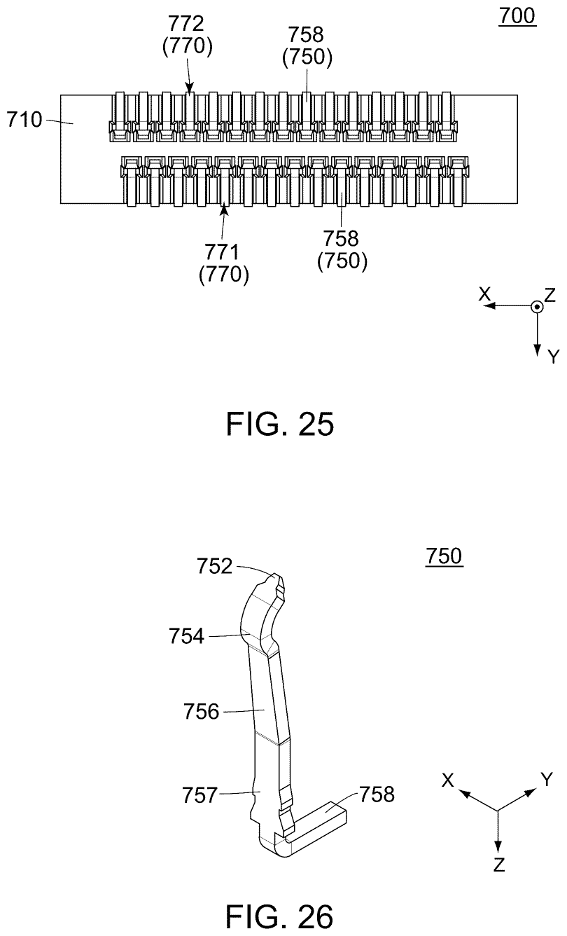

As shown in FIG. 6, the mating connector 700 of the present embodiment is mateable with the connector 100 along a mating direction. Referring to FIG. 21, the mating connector 700 of the present embodiment is a plug connector. In the present embodiment, the mating direction is a Z-direction. Additionally, the mating direction is also referred to as an up-down direction. Specifically, it is assumed that upward is a positive Z-direction while downward is a negative Z-direction.

As shown in FIG. 24, the mating connector 700 of the present embodiment comprises a mating insulator 710 and a plurality of mating contacts 750.

Referring to FIG. 24, the mating insulator 710 of the present embodiment is made of insulator. The mating insulator 710 holds the mating contacts 750. The mating insulator 710 has two outer walls 720.

As shown in FIG. 22, each of the outer walls 720 of the present embodiment extends in a pitch direction. Each of the outer walls 720 has a flat-plate shape perpendicular to a width direction. The two outer walls 720 define opposite ends, respectively, of the mating insulator 710 in the width direction. Each of the outer walls 720 is formed with a plurality of mating receiving portions 722. In the present embodiment, the pitch direction is an X-direction. Additionally, in the present embodiment, the width direction is a Y-direction. The width direction is also referred to as a front-rear direction. Specifically, it is assumed that forward is a positive Y-direction while rearward is a negative Y-direction.

As shown in FIG. 24, each of the mating receiving portions 722 of the present embodiment pierces the outer wall 720 in the width direction. Each of the mating receiving portions 722 is positioned at a lower end of the mating insulator 710 in the up-down direction.

As shown in FIG. 24, the mating insulator 710 has a partition portion accommodating portion 712.

As shown in FIG. 24, the partition portion accommodating portion 712 of the present embodiment is a space extending in the mating direction, or in the up-down direction. The partition portion accommodating portion 712 is opened downward in the up-down direction.

Referring to FIG. 26, each of the mating contacts 750 of the present embodiment is made of metal. Each of the mating contacts 750 is a spring contact. As shown in FIG. 22, the mating contacts 750 form a plurality of mating contact rows 770. Specifically, the mating contacts 750 form two of the mating contact rows 770. Hereinafter, one of the two mating contact rows 770, which is positioned at a front of the mating connector 700, is referred to as a first mating contact row 771, while the other mating contact row 770 positioned at a rear of the mating connector 700 is referred to as a second mating contact row 772. The mating contact 750 of the first mating contact row 771 and the mating contact 750 of the second mating contact row 772 have the same shape as each other. However, the present invention is not limited thereto. Specifically, the mating contacts 750 may form three or more of the mating contact rows 770. The mating contacts 750 correspond to the mating receiving portions 722, respectively.

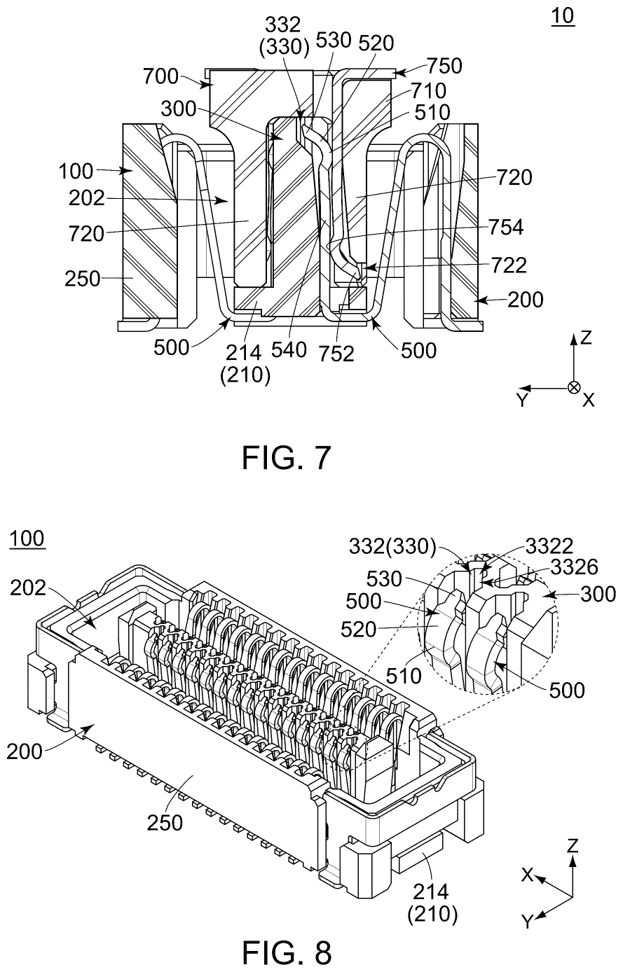

As shown in FIG. 26, each of the mating contacts 750 has a mating distal end portion 752. As shown in FIGS. 6 and 7, each of the mating receiving portions 722 is able to receive the mating distal end portion 752 of the corresponding mating contact 750 upon the mating of the connector 100 with the mating connector 700. However, the present invention is not limited thereto. The mating connector 700 should be configured as follows: the mating contact rows 770 include an outermost contact row which is positioned outermost of the mating contact rows 770 in the width direction; and the mating receiving portion 722 is able to receive the mating distal end portion 752 of the mating contact 750 of the outermost contact row upon the mating of the connector 100 with the mating connector 700.

As shown in FIG. 26, each of the mating contacts 750 has a mating contact point 754, a mating supporting portion 756, a mating held portion 757 and a mating fixed portion 758.

As shown in FIG. 24, the mating contact point 754 of the present embodiment faces inward in the width direction. The mating contact point 754 is positioned above the mating distal end portion 752 in the up-down direction.

As shown in FIG. 24, the mating supporting portion 756 of the present embodiment is positioned above the mating contact point 754 in the up-down direction. The mating supporting portion 756 extends downward in the up-down direction from the mating held portion 757. The mating supporting portion 756 is resiliently deformable. The mating contact point 754 is supported by the mating supporting portion 756. In other words, the mating supporting portion 756 resiliently supports the mating contact point 754. Accordingly, the mating contact point 754 is movable in the width direction.

Referring to FIG. 24, the mating fixed portion 758 of the present embodiment is fixed on a circuit board (not shown) by soldering or the like when the mating connector 700 is mounted on the circuit board. The mating fixed portion 758 extends outward in the width direction from the mating held portion 757. The mating fixed portion 758 defines an upper end of the mating contact 750 in the up-down direction. The mating fixed portion 758 defines an outer end of the mating contact 750 in the width direction.

As shown in FIG. 6, the connector 100 of the present embodiment is mateable along the mating direction with the mating connector 700 which has the mating contacts 750. The connector 100 of the present embodiment is a receptacle connector with a floating structure. However, the present invention is not limited thereto. Specifically, the connector 100 may be a normal receptacle connector with no floating structure, or may be a plug connector.

As shown in FIG. 8, the connector 100 comprises an insulator 200 and a plurality of contacts 500.

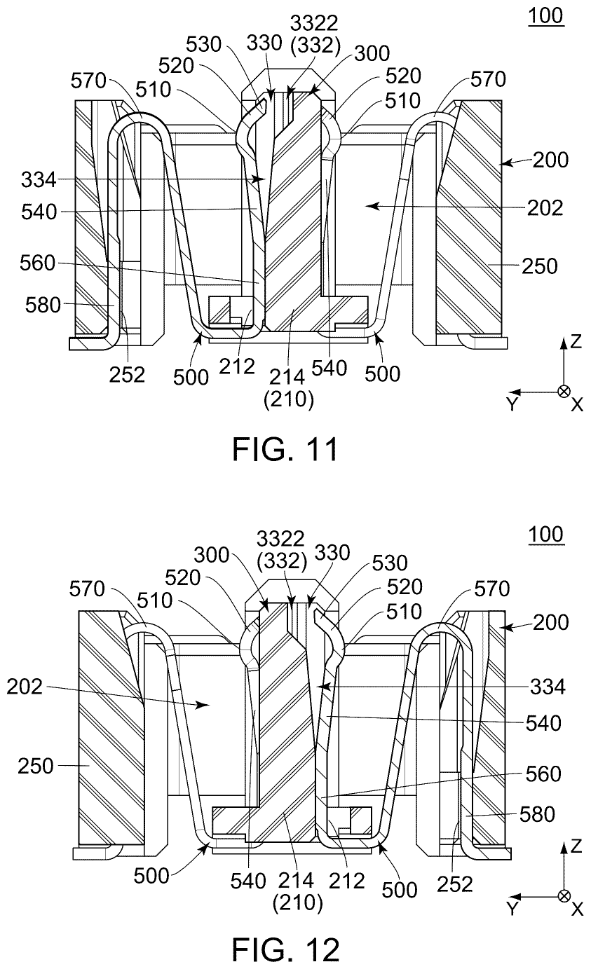

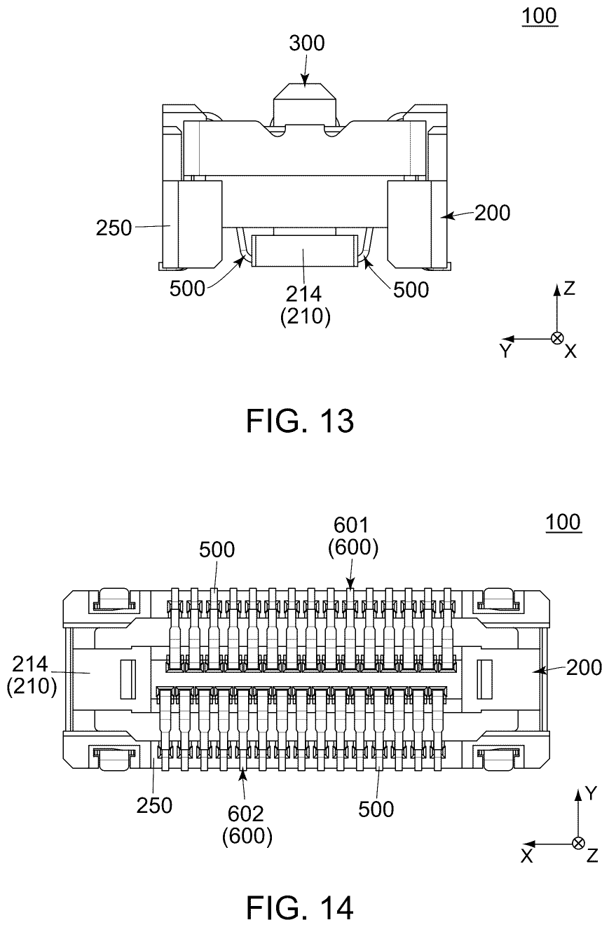

Referring to FIG. 11, the insulator 200 of the present embodiment is made of insulator. The insulator 200 holds the contacts 500. The insulator 200 has a movable housing 210, a fixed housing 250 and an accommodating portion 202.

As shown in FIG. 11, the movable housing 210 of the present embodiment has a partition portion 300. In other words, the insulator 200 has the partition portion 300.

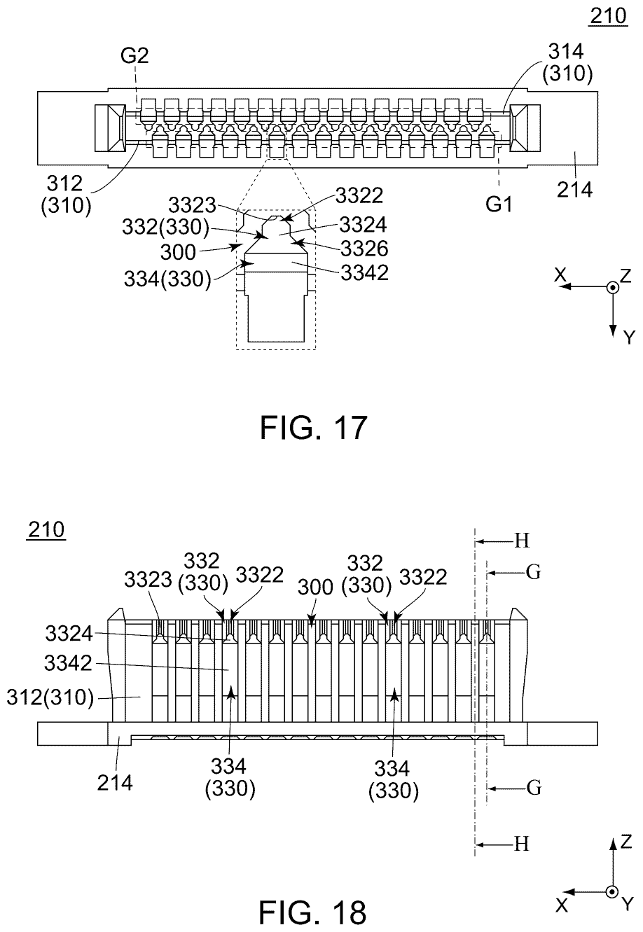

As shown in FIG. 17, the partition portion 300 of the present embodiment has opposite faces 310 in the width direction. The opposite faces 310 include a front face 312 and a rear face 314. The front face 312 is positioned forward of the rear face 314 in the front-rear direction. The front face 312 is directed forward in the front-rear direction. The rear face 314 is directed rearward in the front-rear direction. The partition portion 300 is formed with a plurality of accommodating ditches 330.

As shown in FIG. 11, each of the accommodating ditches 330 of the present embodiment is recessed inward in the width direction. Each of the accommodating ditches 330 is opened upward in the up-down direction. Each of the accommodating ditches 330 is opened outward in the width direction. Each of the accommodating ditches 330 communicates with the accommodating portion 202 in the width direction. As shown in FIG. 17, the accommodating ditches 330 are arranged in a staggered configuration. The accommodating ditches 330 are classified into two groups G1, G2.

In the present embodiment, the number of the accommodating ditches 330 of the group G1 is equal to the number of the accommodating ditches 330 of the group G2. The accommodating ditches 330 of each of the groups G1, G2 are arranged in the pitch direction perpendicular to the mating direction.

As shown in FIG. 17, the accommodating ditches 330 of one of the groups G1, G2 correspond to the accommodating ditches 330, respectively, of a remaining one of the groups G1, G2. The accommodating ditches 330 of one of the groups G1, G2 are positioned on one of the opposite faces 310 of the partition portion 300. The accommodating ditches 330 of a remaining one of the groups G1, G2 are positioned on a remaining one of the opposite faces 310 of the partition portion 300. The accommodating ditches 330 of one of the groups G1, G2 are different in position from the accommodating ditches 330 of a remaining one of the groups G1, G2 in the pitch direction. Each of the accommodating ditches 330 of one of the groups G1, G2 occupies a first area in the pitch direction. Each of the accommodating ditches 330 of a remaining one of the groups G1, G2 occupies a second area in the pitch direction. The first area of each of the accommodating ditches 330 of the one of the groups G1, G2 overlaps with the second area of one of the accommodating ditches 330 of the remaining one of the groups G1, G2 in the pitch direction. More specifically, the first area of each of the accommodating ditches 330 of the one of the groups G1, G2 overlaps with the second area of the corresponding accommodating ditch 330 of the remaining one of the groups G1, G2 in the pitch direction.

As shown in FIG. 17, the accommodating ditches 330 of the group G1 correspond to the accommodating ditches 330, respectively, of the group G2. The accommodating ditches 330 of the group G1 are positioned on the front face 312 of the partition portion 300. The accommodating ditches 330 of the group G2 are positioned on the rear face 314 of the partition portion 300. The accommodating ditches 330 of the group G1 are different in position from the accommodating ditches 330 of the group G2 in the pitch direction. Each of the accommodating ditches 330 of the group G1 occupies an area in the pitch direction. Each of the accommodating ditches 330 of the group G2 occupies another area in the pitch direction. The area of each of the accommodating ditches 330 of the group G1 overlaps with the area of one of the accommodating ditches 330 of the group G2 in the pitch direction. More specifically, the area of each of the accommodating ditches 330 of the group G1 overlaps with the area of the corresponding accommodating ditch 330 of the group G2 in the pitch direction.

As shown in FIG. 17, each of the accommodating ditches 330 has a receiving portion 332.

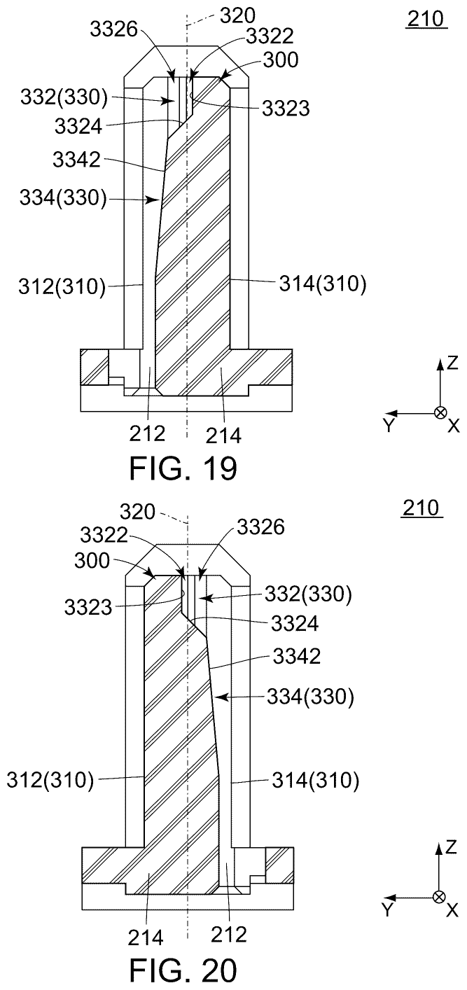

As shown in FIGS. 19 and 20, the receiving portion 332 of the present embodiment defines an upper end of the accommodating ditch 330 in the up-down direction. The receiving portion 332 is opened upward in the up-down direction. The receiving portion 332 is recessed inward in the width direction. The receiving portion 332 is opened outward in the width direction.

As shown in FIGS. 19 and 20, in the width direction, the receiving portion 332 extends across a middle 320 of the partition portion 300.

As described above, the accommodating ditches 330 of the one of the groups G1, G2 are different in position from the accommodating ditches 330 of the remaining one of the groups G1, G2 in the pitch direction, and the receiving portion 332 extends across the middle 320 of the partition portion 300 in the width direction. This enables the partition portion 300 of the connector 100 of the present embodiment to have a reduced thickness in the width direction. Specifically, the connector 100 of the present embodiment can have a reduced size in the width direction.

More specifically, referring to FIGS. 17 and 19, the receiving portion 332 of each of the accommodating ditches 330 of the group G1, which is positioned on the front face 312 of the partition portion 300, extends across the middle 320 of the partition portion 300 toward the rear face 314 of the partition portion 300. It is noted that the receiving portion 332 of each of the accommodating ditches 330 of the group G1 does not reach the rear face 314 of the partition portion 300.

Additionally, referring to FIGS. 17 and 20, the receiving portion 332 of each of the accommodating ditches 330 of the group G2, which is positioned on the rear face 314 of the partition portion 300, extends across the middle 320 of the partition portion 300 toward the front face 312 of the partition portion 300. It is noted that the receiving portion 332 of each of the accommodating ditches 330 of the group G2 does not reach the front face 312 of the partition portion 300.

As shown in FIG. 17, the receiving portion 332 has a narrow portion 3322 and a wide portion 3326.

As shown in FIG. 17, the narrow portion 3322 of the present embodiment is positioned inward of the wide portion 3326 in the width direction. The narrow portion 3322 defines an inner end of the receiving portion 332 in the width direction. The narrow portion 3322 communicates with the wide portion 3326 in the width direction. The narrow portion 3322 has an inner surface 3323. In other words, each of the receiving portions 332 does not pierce the partition portion 300 in the width direction.

As described above, the insulator 200 of the present embodiment is configured so that each of the receiving portions 332 does not pierce the partition portion 300 in the width direction. Accordingly, molten resin can easily flow when the insulator 200 of the present embodiment is molded. However, the present invention is not limited thereto, but the receiving portion 332 may pierce the partition portion 300 in the width direction.

As shown in FIGS. 19 and 20, the inner surface 3323 defines an inner end of the narrow portion 3322 in the width direction. The inner surface 3323 faces outward in the width direction. The inner surface 3323 is a plane perpendicular to the width direction. Referring to FIGS. 17 and 19, the inner surface 3323 of the receiving portion 332 of each of the accommodating ditches 330 of the group G1 is positioned rearward of the middle 320 of the partition portion 300 in the front-rear direction. Referring to FIGS. 17 and 20, the inner surface 3323 of the receiving portion 332 of each of the accommodating ditches 330 of the group G2 is positioned forward of the middle 320 of the partition portion 300 in the front-rear direction.

As shown in FIG. 17, the wide portion 3326 of the present embodiment is positioned outward of the narrow portion 3322 in the width direction. The wide portion 3326 defines an outer end of the receiving portion 332 in the width direction. A size of a part of the wide portion 3326 in the pitch direction decreases as the part approaches the narrow portion 3322. As shown in FIG. 19, the wide portion 3326 couples the narrow portion 3322 and an additional receiving portion 334 with each other.

As shown in FIG. 19, the receiving portion 332 has a first surface 3324 facing in the mating direction. The first surface 3324 is oblique to both the mating direction and the width direction. The first surface 3324 faces upward in the up-down direction and outward in the width direction. The first surface 3324 extends upward in the up-down direction and inward in the width direction.

As shown in FIG. 19, each of the accommodating ditches 330 further has the additional receiving portion 334.

As shown in FIG. 19, the additional receiving portion 334 of the present embodiment is positioned below the receiving portion 332 in the up-down direction. Referring to FIGS. 6 and 11, the additional receiving portion 334 partially receives a supporting portion 540 upon the mating of the connector 100 with the mating connector 700. As shown in FIG. 19, the additional receiving portion 334 has a second surface 3342 facing in the mating direction. The second surface 3342 is oblique to both the mating direction and the width direction. The second surface 3342 faces upward in the up-down direction and outward in the width direction. The second surface 3342 extends upward in the up-down direction and inward in the width direction. A first angle that the first surface 3324 makes with the mating direction is greater than a second angle that the second surface 3342 makes with the mating direction. An angle that the first surface 3324 makes with the width direction is smaller than an angle that the second surface 3342 makes with the width direction.

As shown in FIGS. 19 and 20, the movable housing 210 has a plurality of first holding portions 212. Each of the first holding portions 212 is positioned around a lower end of the movable housing 210 in the up-down direction. Each of the first holding portions 212 is positioned below the partition portion 300 in the up-down direction.

As shown in FIG. 19, the movable housing 210 has a base portion 214. The base portion 214 defines the lower end of the movable housing 210 in the up-down direction. The partition portion 300 extends upward in the up-down direction from the base portion 214.

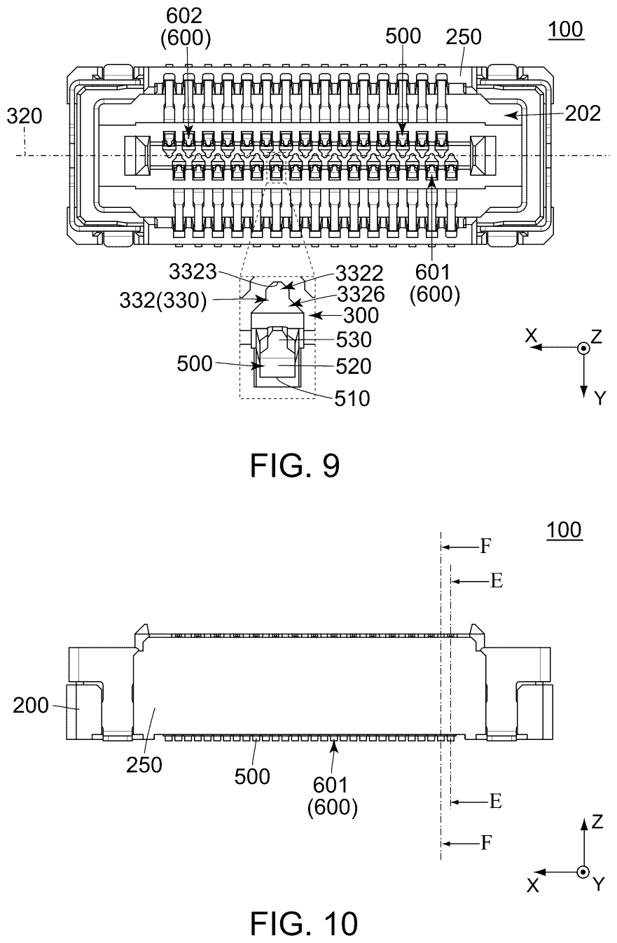

As shown in FIG. 9, the fixed housing 250 defines an outer end of the insulator 200 in a direction perpendicular to the mating direction. The fixed housing 250 defines opposite outer ends of the insulator 200 in the width direction perpendicular to the mating direction. The fixed housing 250 defines opposite outer ends of the insulator 200 in the pitch direction perpendicular to both the mating direction and the width direction. The partition portion 300 is surrounded by the fixed housing 250 in a plane perpendicular to the up-down direction.

As shown in FIGS. 11 and 12, the fixed housing 250 has a plurality of second holding portions 252. Each of the second holding portions 252 is positioned around a lower end of the fixed housing 250 in the up-down direction. Each of the second holding portions 252 is positioned around an outer end of the fixed housing 250 in the width direction.

As shown in FIG. 9, the accommodating portion 202 of the present embodiment is opened upward in the up-down direction. The accommodating portion 202 is surrounded by the fixed housing 250 in the plane perpendicular to the up-down direction. As shown in FIG. 6, the accommodating portion 202 accommodates a part of the mating connector 700 when the connector 100 and the mating connector 700 are mated with each other.

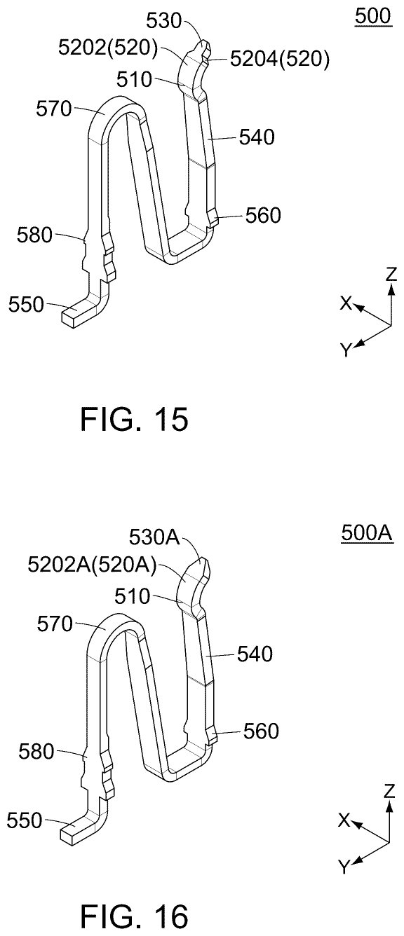

Referring to FIG. 15, each of the contacts 500 of the present embodiment is made of metal. Each of the contacts 500 is a spring contact. As shown in FIG. 6, the contact 500 is brought into contact with the mating contact 750 at two points when the connector 100 and the mating contact 750 are mated with each other. The mating contact point 754 is brought into contact with the contact 500 upon the mating of the connector 100 with the mating connector 700. As shown in FIG. 9, the contacts 500 are arranged in a staggered configuration. The contacts 500 from two contact rows 600. Hereinafter, one of the contact rows 600, which is positioned at a front of the connector 100, is referred to as a first contact row 601, while the other contact row 600 positioned at a rear of the connector 100 is referred to as a second contact row 602. The contact 500 of the first contact row 601 and the contact 500 of the second contact row 602 have the same shape as each other.

As shown in FIG. 9, the contacts 500 correspond to the accommodating ditches 330, respectively. Each of the contacts 500 is partially accommodated in the corresponding accommodating ditch 330.

Referring to FIGS. 9 and 17, the contacts 500 of the first contact row 601 correspond to the accommodating ditches 330, respectively, of the group G1. The contacts 500 of the second contact row 602 correspond to the accommodating ditches 330, respectively, of the group G2. Each of the contacts 500 of the first contact row 601 is partially accommodated in the corresponding accommodating ditch 330 of the group G1. Each of the contacts 500 of the second contact row 602 is partially accommodated in the corresponding accommodating ditch 330 of the group G2.

As shown in FIG. 15, each of the contacts 500 has a contact point 510 and a distal end portion 530.

As shown in FIG. 9, the contact point 510 of the present embodiment faces outward in the width direction. The contact point 510 is positioned in the accommodating portion 202. The narrow portion 3322 of the receiving portion 332 of each of the accommodating ditches 330 is smaller than the contact point 510 of the corresponding contact 500. That is, in the pitch direction, a size of the narrow portion 3322 of the receiving portion 332 of each of the accommodating ditches 330 is smaller than a size of the contact point 510 of the corresponding contact 500. As shown in FIG. 6, the contact point 510 is brought into contact with the mating contact 750 when the connector 100 and the mating connector 700 are mated with each other.

As shown in FIG. 15, the distal end portion 530 of the present embodiment defines a free end of the contact 500. The distal end portion 530 is positioned at an upper end of the contact 500 in the up-down direction. In each of the contacts 500, the distal end portion 530 is smaller than the contact point 510. More specifically, in each of the contacts 500, the whole part of the distal end portion 530 is smaller than the contact point 510. That is, in the pitch direction, a size of the distal end portion 530 is smaller than the size of the contact point 510.

As shown in FIG. 6, the receiving portion 332 of each of the accommodating ditches 330 is able to receive the distal end portion 530 of the corresponding contact 500 upon the mating of the connector 100 with the mating connector 700. However, the present invention is not limited thereto. Specifically, the receiving portion 332 of each of the accommodating ditches 330 should be able to receive, at least in part, the distal end portion 530 of the corresponding contact 500 upon the mating of the connector 100 with the mating connector 700. The narrow portion 3322 of the receiving portion 332 of each of the accommodating ditches 330 receives a part of the distal end portion 530 of the corresponding contact 500 upon the mating of the connector 100 with the mating connector 700. It is noted that the inner surface 3323 of the narrow portion 3322 of the receiving portion 332 of each of the accommodating ditches 330 is in non-contact with the distal end portion 530 of the corresponding contact 500 upon the mating of the connector 100 with the mating connector 700.

As shown in FIG. 15, each of the contacts 500 further has a guide portion 520.

As shown in FIG. 11, the guide portion 520 of the present embodiment extends upward in the up-down direction and inward in the width direction from the contact point 510. The guide portion 520 extends downward in the up-down direction and outward in the width direction from the distal end portion 530. The guide portion 520 couples the contact point 510 and the distal end portion 530 with each other. The guide portion 520 intersects with the mating direction, or with the up-down direction. As shown in FIG. 15, in each of the contacts 500, the distal end portion 530 is smaller than the guide portion 520. That is, in the pitch direction, the size of the distal end portion 530 is smaller than a size of the guide portion 520. The guide portion 520 has a main portion 5202 and a tapered portion 5204.

As shown in FIG. 15, the main portion 5202 of the present embodiment defines an outer end of the guide portion 520 in the width direction. The main portion 5202 couples the contact point 510 and the tapered portion 5204 with each other. The main portion 5202 has a constant size in the pitch direction. In the pitch direction, the size of the main portion 5202 is greater than the size of the distal end portion 530.

As shown in FIG. 15, the tapered portion 5204 of the present embodiment defines an inner end of the guide portion 520 in the width direction. The tapered portion 5204 is coupled with the distal end portion 530. The tapered portion 5204 is tapered toward the distal end portion 530.

As shown in FIG. 15, each of the contacts 500 further has the supporting portion 540.

As shown in FIG. 15, the supporting portion 540 of the present embodiment is positioned below the contact point 510 in the up-down direction. The supporting portion 540 is resiliently deformable. The contact point 510 is supported by the supporting portion 540. In other words, the supporting portion 540 resiliently supports the contact point 510. Accordingly, the contact point 510 is movable in the width direction. As shown in FIG. 15, each of the contacts 500 further has a fixed portion 550, a first held portion 560, a connection portion 570 and a second held portion 580.

Referring to FIGS. 11 and 15, the fixed portion 550 of the present embodiment is fixed on a circuit board (not shown) by soldering or the like when the connector 100 is mounted on the circuit board. The fixed portion 550 extends outward in the width direction. The fixed portion 550 defines an outer end of the contact 500 in the width direction. The fixed portion 550 defines a lower end of the contact 500 in the up-down direction.

As shown in FIG. 15, the first held portion 560 of the present embodiment extends upward in the up-down direction from the connection portion 570. As shown in FIG. 11, the first held portion 560 is held by the first holding portion 212. More specifically, the first held portion 560 is press-fit into the first holding portion 212.

As shown in FIG. 15, the connection portion 570 of the present embodiment couples the first held portion 560 and the second held portion 580 with each other. The connection portion 570 is resiliently deformable. Referring to FIG. 11, the movable housing 210 is movable relative to the fixed housing 250 in the plane perpendicular to the up-down direction by the resilient deformations of the connection portions 570.

As shown in FIG. 15, the second held portion 580 of the present embodiment extends upward in the up-down direction from the fixed portion 550. The second held portion 580 extends downward in the up-down direction from the connection portion 570. As shown in FIG. 11, the second held portion 580 is held by the second holding portion 252. More specifically, the second held portion 580 is press-fit into the second holding portion 252.

The structure of the contact 500 is not limited thereto. For example, the contact 500 can be modified as described below.

As shown in FIG. 16, a contact 500A according to a modification of the present invention has a contact point 510, a guide portion 520A, a distal end portion 530A, a supporting portion 540, a fixed portion 550, a first held portion 560, a connection portion 570 and a second held portion 580. Components of the contact 500A other than the guide portion 520A and the distal end portion 530A have structures same as those of the aforementioned embodiment. Accordingly, a detailed description thereabout is omitted.

As shown in FIG. 16, dissimilar to the guide portion 520 of the contact 500 of the aforementioned embodiment, the guide portion 520A of the present modification consists only of a main portion 5202A which has a constant size in the pitch direction. Dissimilar to the distal end portion 530 of the contact 500 of the aforementioned embodiment, the distal end portion 530A of the present modification is tapered from the guide portion 520A toward a free end of the contact 500A. It is noted that, in an assembly 10 of the present modification, the receiving portion 332 of each of the accommodating ditches 330 of the partition portion 300 of the insulator 200 is able to receive, at least in part, the distal end portion 530A of a corresponding one of the contacts 500A upon mating of a connector 100 with the mating connector 700.

### Second Embodiment

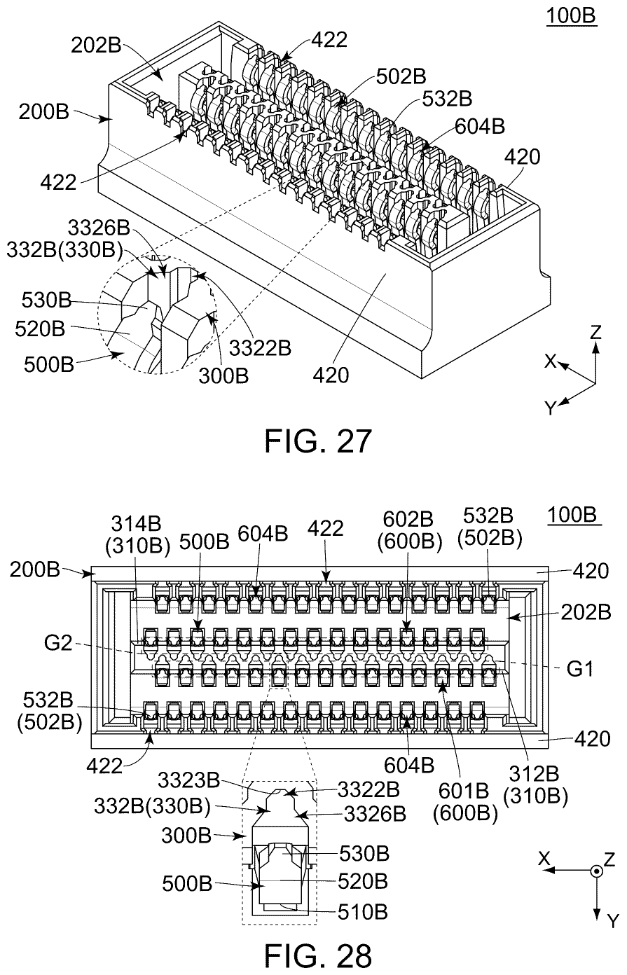

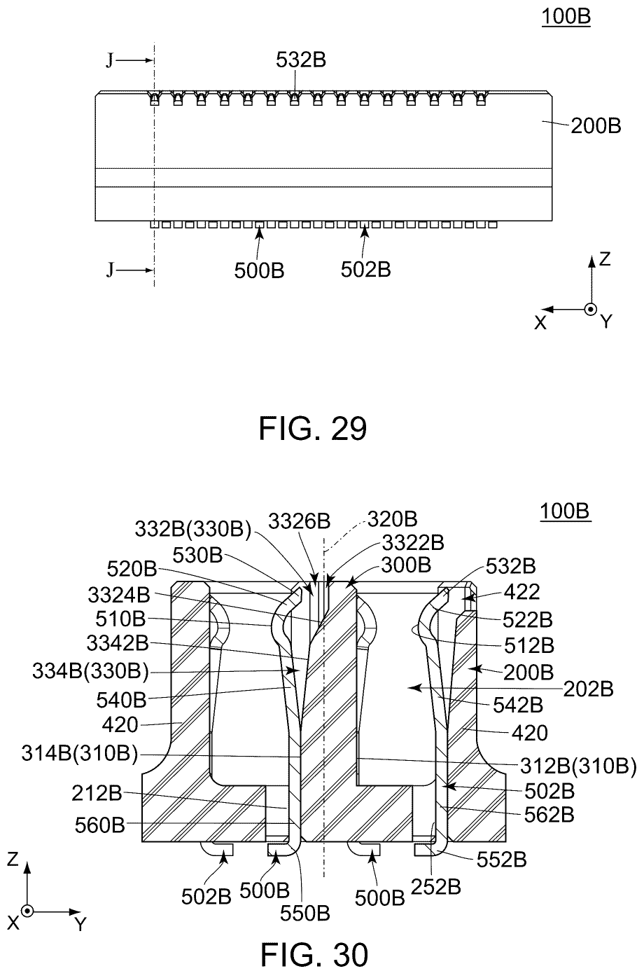

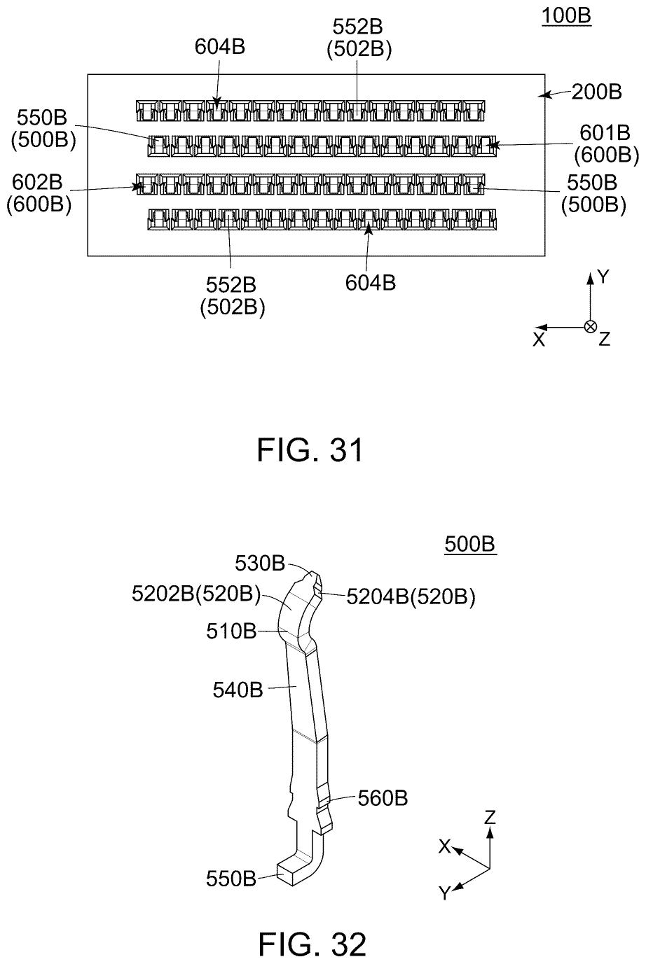

Referring to FIG. 27, an assembly (not shown) according to a second embodiment of the present invention comprises a connector 100B and a mating connector (not shown).

Referring to FIG. 27, the connector 100B of the present embodiment is mateable along the mating direction with the mating connector which has mating contacts (not shown). Dissimilar to the connector 100 and the mating connector 700 of the aforementioned embodiment, the connector 100B of the present embodiment is a plug connector while the mating connector of the present embodiment is a receptacle connector. As for directions and orientations in the present embodiment, expressions same as those of the first embodiment will be used hereinbelow.

As shown in FIG. 27, the connector 100B comprises an insulator 200B, a plurality of first contacts 500B and a plurality of second contacts 502B. The first contact 500B is also referred to as a contact 500B.

Referring to FIG. 28, the insulator 200B of the present embodiment is made of insulator. The insulator 200B defines an outer end of the connector 100B in a direction perpendicular to the mating direction. The insulator 200B defines opposite outer ends of the connector 100B in the width direction perpendicular to the mating direction. The insulator 200B defines opposite outer ends of the connector 100B in the pitch direction perpendicular to both the mating direction and the width direction. The insulator 200B holds the contacts 500B.

As shown in FIG. 30, insulator 200B has a partition portion 300B.

As shown in FIG. 30, the partition portion 300B of the present embodiment has opposite faces 310B in the width direction. The opposite faces 310B include a front face 312B and a rear face 314B. The front face 312B is positioned forward of the rear face 314B in the front-rear direction. The front face 312B is directed forward in the front-rear direction. The rear face 314B is directed rearward in the front-rear direction.

As shown in FIG. 28, the partition portion 300B is formed with a plurality of accommodating ditches 330B.

As shown in FIG. 30, each of the accommodating ditches 330B of the present embodiment is recessed inward in the width direction. Each of the accommodating ditches 330B is opened upward in the up-down direction. Each of the accommodating ditches 330B is opened outward in the width direction. As shown in FIG. 28, the accommodating ditches 330B are arranged in a staggered configuration. The accommodating ditches 330B are classified into two groups G1, G2. In the present embodiment, the number of the accommodating ditches 330B of the group G1 is equal to the number of the accommodating ditches 330B of the group G2. The accommodating ditches 330B of each of the groups G1, G2 are arranged in the pitch direction perpendicular to the mating direction.

As shown in FIG. 28, the accommodating ditches 330B of one of the groups G1, G2 correspond to the accommodating ditches 330B, respectively, of a remaining one of the groups G1, G2. The accommodating ditches 330B of one of the groups G1, G2 are positioned on one of the opposite faces 310B of the partition portion 300B. The accommodating ditches 330B of a remaining one of the groups G1, G2 are positioned on a remaining one of the opposite faces 310B of the partition portion 300B. The accommodating ditches 330B of one of the groups G1, G2 are different in position from the accommodating ditches 330B of a remaining one of the groups G1, G2 in the pitch direction. Each of the accommodating ditches 330B of one of the groups G1, G2 occupies a first area in the pitch direction. Each of the accommodating ditches 330B of a remaining one of the groups G1, G2 occupies a second area in the pitch direction. The first area of each of the accommodating ditches 330B of the one of the groups G1, G2 overlaps with the second area of one of the accommodating ditches 330B of the remaining one of the groups G1, G2 in the pitch direction. More specifically, the first area of each of the accommodating ditches 330B of the one of the groups G1, G2 overlaps with the second area of the corresponding accommodating ditch 330B of the remaining one of the groups G1, G2 in the pitch direction.

As shown in FIG. 28, the accommodating ditches 330B of the group G1 correspond to the accommodating ditches 330B, respectively, of the group G2. The accommodating ditches 330B of the group G1 are positioned on the front face 312B of the partition portion 300B. The accommodating ditches 330B of the group G2 are positioned on the rear face 314B of the partition portion 300B. The accommodating ditches 330B of the group G1 are different in position from the accommodating ditches 330B of the group G2 in the pitch direction. Each of the accommodating ditches 330B of the group G1 occupies an area in the pitch direction. Each of the accommodating ditches 330B of the group G2 occupies another area in the pitch direction. The area of each of the accommodating ditches 330B of the group G1 overlaps with the area of one of the accommodating ditches 330B of the group G2 in the pitch direction. More specifically, the area of each of the accommodating ditches 330B of the group G1 overlaps with the area of the corresponding accommodating ditch 330 of the group G2 in the pitch direction.

As shown in FIG. 30, each of the accommodating ditches 330B has a receiving portion 332B.

As shown in FIG. 30, the receiving portion 332B of the present embodiment defines an upper end of the accommodating ditch 330B in the up-down direction. The receiving portion 332B is opened upward in the up-down direction. The receiving portion 332B is recessed inward in the width direction. The receiving portion 332B is opened outward in the width direction. In the width direction, the receiving portion 332B extends across a middle 320B of the partition portion 300B.

As described above, the accommodating ditches 330B of the one of the groups G1, G2 are different in position from the accommodating ditches 330B of the remaining one of the groups G1, G2 in the pitch direction, and the receiving portion 332B extends across the middle 320B of the partition portion 300B in the width direction. This enables the partition portion 300B of the connector 100B of the present embodiment to have a reduced thickness in the width direction. Specifically, the connector 100B of the present embodiment can have a reduced size in the width direction.

As shown in FIG. 30, the receiving portion 332B has a narrow portion 3322B and a wide portion 3326B. The narrow portion 3322B and the wide portion 3326B of the present embodiment have structures same as those of the narrow portion 3322 and the wide portion 3326 of the aforementioned embodiment. Accordingly, a detailed description thereabout is omitted.

As shown in FIG. 30, each of the accommodating ditches 330B further has an additional receiving portion 334B. The additional receiving portion 334B of the present embodiment has a structure same as that of the additional receiving portion 334 of the aforementioned embodiment. Accordingly, a detailed description thereabout is omitted.

As shown in FIG. 30, the insulator 200B has a plurality of first holding portions 212B, two outer walls 420 and an accommodating portion 202B.

As shown in FIG. 30, each of the first holding portions 212B of the present embodiment is positioned around a lower end of the insulator 200B in the up-down direction. Each of the first holding portions 212B is positioned below the partition portion 300B in the up-down direction.

As shown in FIG. 28, each of the outer walls 420 of the present embodiment extends in the pitch direction. Each of the outer walls 420 has a flat-plate shape perpendicular to the width direction. The two outer walls 420 define opposite ends, respectively, of the insulator 200B in the width direction. The partition portion 300B is positioned between the two outer walls 420 in the width direction. Each of the outer walls 420 is formed with a plurality of outer wall-side receiving portions 422.

As shown in FIG. 30, each of the outer wall-side receiving portions 422 of the present embodiment pierces the outer wall 420 in the width direction. Each of the outer wall-side receiving portions 422 is positioned at an upper end of the insulator 200B in the up-down direction.

As shown in FIG. 30, each of the outer walls 420 has a plurality of second holding portions 252B.

As shown in FIG. 30, each of the second holding portions 252B of the present embodiment is positioned around a lower end of the outer wall 420 in the up-down direction. Each of the second holding portions 252B is positioned outward of the partition portion 300B in the width direction.

As shown in FIG. 30, the accommodating portion 202B of the present embodiment is opened upward in the up-down direction. Each of the accommodating ditches 330B communicates with the accommodating portion 202B in the width direction. Referring to FIG. 30, the accommodating portion 202B accommodates a part of the mating connector when the connector 100B and the mating connector are mated with each other.

Referring to FIG. 32, each of the first contacts 500B of the present embodiment is made of metal. Each of the first contacts 500B is a spring contact. Referring to FIG. 30, the first contact 500B is brought into contact with the mating contact when the connector 100B and the mating connector are mated with each other. As shown in FIG. 28, the first contacts 500B are arranged in a staggered configuration. The first contacts 500B from two contact rows 600B. Hereinafter, one of the contact rows 600B, which is positioned at a front of the connector 100B, is referred to as a first contact row 601B, while the other contact row 600B positioned at a rear of the connector 100B is referred to as a second contact row 602B. The first contact 500B of the first contact row 601B and the first contact 500B of the second contact row 602B have the same shape as each other.

As shown in FIG. 30, the first contacts 500B correspond to the accommodating ditches 330B, respectively. Each of the first contacts 500B is partially accommodated in the corresponding accommodating ditch 330B.

As shown in FIG. 28, the first contacts 500B of the first contact row 601B correspond to the accommodating ditches 330B, respectively, of the group G1. The first contacts 500B of the second contact row 602B correspond to the accommodating ditches 330B, respectively, of the group G2. Each of the first contacts 500B of the first contact row 601B is partially accommodated in the corresponding accommodating ditch 330B of the group G1. Each of the first contacts 500B of the second contact row 602B is partially accommodated in the corresponding accommodating ditch 330B of the group G2.

As shown in FIG. 32, each of the first contacts 500B has a contact point 510B and a distal end portion 530B. The contact point 510B and the distal end portion 530B of the present embodiment have structures same as those of the contact point 510 and the distal end portion 530 of the aforementioned embodiment. Accordingly, a detailed description thereabout is omitted.

As shown in FIG. 32, each of the first contacts 500B further has a guide portion 520B. The guide portion 520B has a main portion 5202B and a tapered portion 5204B.

The main portion 5202B and the tapered portion 5204B of the present embodiment have structures same as those of the main portion 5202 and the tapered portion 5204 of the aforementioned embodiment. Accordingly, a detailed description thereabout is omitted.

As shown in FIG. 32, each of the first contacts 500B further has a supporting portion 540B. The supporting portion 540B of the present embodiment has a structure same as that of the supporting portion 540 of the aforementioned embodiment. Accordingly, a detailed description thereabout is omitted.

As shown in FIG. 32, each of the first contacts 500B further has a fixed portion 550B and a held portion 560B.

Referring to FIG. 30, the fixed portion 550B of the present embodiment is fixed on a circuit board (not shown) by soldering or the like when the connector 100B is mounted on the circuit board. The fixed portion 550B extends outward in the width direction.

As shown in FIG. 32, the held portion 560B of the present embodiment extends upward in the up-down direction from the fixed portion 550B. The held portion 560B extends downward in the up-down direction from the supporting portion 540B. The held portion 560B couples the fixed portion 550B and the supporting portion 540B with each other. As shown in FIG. 30, the held portion 560B is held by the first holding portion 212B. More specifically, the held portion 560B is press-fit into the first holding portion 212B.

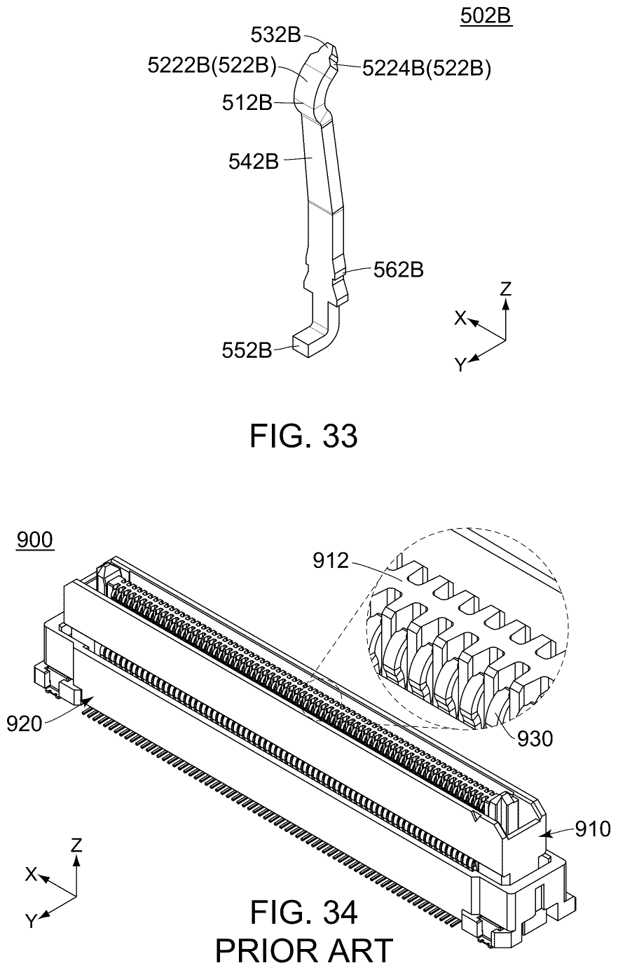

Referring to FIG. 33, each of the second contacts 502B of the present embodiment is made of metal. Each of the second contacts 502B is a spring contact. Referring to FIG. 30, the second contact 502B is brought into contact with the mating contact when the connector 100B and the mating connector are mated with each other. As shown in FIG. 28, the second contacts 502B from two contact rows 604B. Hereinafter, one of the contact rows 604B, which is positioned at the front of the connector 100B, is referred to as a first row, while the other contact row 604B positioned at the rear of the connector 100B is referred to as a second row. The second contact 502B of the first row and the second contact 502B of the second row have the same shape as each other. The second contacts 502B correspond to the outer wall-side receiving portions 422, respectively.

As shown in FIG. 33, each of the second contacts 502B has a contact point 512B and a distal end portion 532B.

As shown in FIG. 30, the contact point 512B of the present embodiment faces inward in the width direction. The contact point 512B is positioned in the accommodating portion 202B. The contact point 512B is brought into contact with the mating contact when the connector 100B and the mating connector are mated with each other.

As shown in FIG. 33, the distal end portion 532B of the present embodiment defines a free end of the second contact 502B. The distal end portion 532B is positioned at an upper end of the second contact 502B in the up-down direction. In each of the second contacts 502B, the distal end portion 532B is smaller than the contact point 512B. More specifically, in each of the second contacts 502B, the whole part of the distal end portion 532B is smaller than the contact point 512B. That is, in the pitch direction, a size of the distal end portion 532B is smaller than a size of the contact point 512B. Referring to FIG. 30, the outer wall-side receiving portion 422 is able to receive the distal end portion 532B of the corresponding second contact 502B upon the mating of the connector 100B with the mating connector.

As shown in FIG. 33, each of the second contacts 502B further has a guide portion 522B.

As shown in FIG. 30, the guide portion 522B of the present embodiment extends upward in the up-down direction and outward in the width direction from the contact point 512B. The guide portion 522B extends downward in the up-down direction and inward in the width direction from the distal end portion 532B. The guide portion 522B couples the contact point 512B and the distal end portion 532B with each other. The guide portion 522B intersects with the mating direction, or with the up-down direction. As shown in FIG. 33, in each of the second contacts 502B, the distal end portion 532B is smaller than the guide portion 522B. That is, in the pitch direction, the size of the distal end portion 532B is smaller than a size of the guide portion 522B. The guide portion 522B has a main portion 5222B and a tapered portion 5224B.

As shown in FIG. 33, the main portion 5222B of the present embodiment defines an inner end of the guide portion 522B in the width direction. The main portion 5222B couples the contact point 512B and the tapered portion 5224B with each other. The main portion 5222B has a constant size in the pitch direction. In the pitch direction, a size of the main portion 5222B is greater than the size of the distal end portion 532B.

As shown in FIG. 33, the tapered portion 5224B of the present embodiment defines an outer end of the guide portion 522B in the width direction. The tapered portion 5224B is coupled with the distal end portion 532B. The tapered portion 5224B is tapered toward the distal end portion 532B.

As shown in FIG. 33, each of the second contacts 502B further has a supporting portion 542B.

As shown in FIG. 33, the supporting portion 542B of the present embodiment is positioned below the contact point 512B in the up-down direction. The supporting portion 542B is resiliently deformable. The contact point 512B is supported by the supporting portion 542B. That is, the supporting portion 542B resiliently supports the contact point 512B. Accordingly, the contact point 512B is movable in the width direction.

As shown in FIG. 33, each of the second contacts 502B further has a fixed portion 552B and a held portion 562B.

Referring to FIG. 30, the fixed portion 552B of the present embodiment is fixed on the circuit board (not shown) by soldering or the like when the connector 100B is mounted on the circuit board. The fixed portion 552B extends inward in the width direction.

As shown in FIG. 33, the held portion 562B of the present embodiment extends upward in the up-down direction from the fixed portion 552B. The held portion 562B extends downward in the up-down direction from the supporting portion 542B. The held portion 562B couples the fixed portion 552B and the supporting portion 542B with each other. As shown in FIG. 30, the held portion 562B is held by the second holding portion 252B. More specifically, the held portion 562B is press-fit into the second holding portion 252B.

Although the preceding description explains the embodiments of the present invention with reference to the drawings in which the assembly, the connectors and the mating connector have the specific shapes, the present invention is not limited thereto. Specifically, the assembly 10 and the connector 100, 100B may have various shapes and structures.

Although the connector 100 of the first embodiment has the two contact rows 600, the present invention is not limited thereto. Specifically, the connector 100 may have three or more of the contact rows 600.

Although the connector 100B of the second embodiment has the four contact rows 600B, 604B, the present invention is not limited thereto. Specifically, the connector 100B may have five or more of the contact rows 600B, 604B.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

1: A connector mateable along a mating direction with a mating connector which has a mating contact, wherein:
the connector has an insulator and a plurality of contacts;
the insulator holds the contacts;
the insulator has a partition portion;
the partition portion has opposite faces in a width direction perpendicular to the mating direction;
the partition portion is formed with a plurality of accommodating ditches;
the accommodating ditches are classified into two groups;
the accommodating ditches of each of the groups are arranged in a pitch direction perpendicular to both the mating direction and the width direction;
the accommodating ditches of one of the groups are positioned on one of the opposite faces of the partition portion;
the accommodating ditches of a remaining one of the groups are positioned on a remaining one of the opposite faces of the partition portion;
the accommodating ditches of one of the groups are different in position from the accommodating ditches of a remaining one of the groups in the pitch direction;
each of the accommodating ditches has a receiving portion;
in the width direction, the receiving portion extends across a middle of the partition portion;
the contacts correspond to the accommodating ditches, respectively;
each of the contacts is partially accommodated in the corresponding accommodating ditch;
the contacts form two contact rows;
each of the contacts has a contact point and a distal end portion;
the contact point is brought into contact with the mating contact when the connector and the mating connector are mated with each other; and
the receiving portion of each of the accommodating ditches is able to receive, at least in part, the distal end portion of the corresponding contact upon the mating of the connector with the mating connector.

2: The connector as recited in claim 1, wherein:
in each of the contacts, the distal end portion is smaller than the contact point;
the receiving portion has a narrow portion;
the narrow portion of the receiving portion of each of the accommodating ditches is smaller than the contact point of the corresponding contact;
each of the accommodating ditches of one of the groups occupies a first area in the pitch direction;
each of the accommodating ditches of a remaining one of the groups occupies a second area in the pitch direction; and
the first area of each of the accommodating ditches of the one of the groups overlaps with the second area of one of the accommodating ditches of the remaining one of the groups in the pitch direction.

3: The connector as recited in claim 1, wherein:
each of the contacts further has a guide portion;
the guide portion couples the contact point and the distal end portion with each other; and
the guide portion intersects with the mating direction.

4: The connector as recited in claim 1, wherein:
each of the contacts further has a supporting portion;
the supporting portion resiliently supports the contact point;
each of the accommodating ditches further has an additional receiving portion; and
the additional receiving portion partially receives the supporting portion upon the mating of the connector with the mating connector.

5: The connector as recited in claim 4, wherein:
the receiving portion has a first surface facing in the mating direction;
the additional receiving portion has a second surface facing in the mating direction;
the first surface and the mating direction make a first angle;
the second surface and the mating direction make a second angle; and
the first angle is greater than the second angle.

6: An assembly comprising the connector as recited in claim 1 and the mating connector, wherein:
the mating connector comprises a mating insulator and a plurality of the mating contacts;
the mating insulator holds the mating contacts;
the mating insulator has two outer walls;
each of the outer walls extends in the pitch direction;
each of the outer walls is formed with a plurality of mating receiving portions;
each of the mating receiving portions pierces the outer wall in the width direction;
the mating contacts form mating contact rows;
the mating contact rows include an outermost contact row which is positioned outermost of the mating contact rows in the width direction;
each of the mating contacts has a mating distal end portion; and
the mating receiving portion is able to receive the mating distal end portion of the mating contact of the outermost contact row upon the mating of the connector with the mating connector.
